(19) United States
(12) Patent Application Publication
(10) Pub. No.: US 2026/0150033 A1
(43) Pub. Date: May 28, 2026

(54) Intelligent Pairwise Master Key (PMK) Cache Sharing

(71) Applicant: Arista Networks, Inc., Santa Clara, CA (US)

(72) Inventors: Karthikeyan BALASUBRAMANIAN, Bangalore (IN); Senthilraj SHANMUGAVADIVEL, Bengaluru (IN)

(21) Appl. No.: 18/958,800

(22) Filed: Nov. 25, 2024

(51) Int. Cl. H04W 48/16; H04W 48/20; H04W 76/25; H04W 84/12

(52) U.S. Cl. CPC H04W 48/16; H04W 48/20; H04W 76/25; H04W 84/12

(57) ABSTRACT

Techniques for intelligently sharing Pairwise Master Key (PMK) cache information among Wi-Fi access points (APs) in a network are provided. With these techniques, Wi-Fi clients that roam from a first radio frequency (RF) coverage area of the network to a second RF coverage area of the network that is separate (i.e., disjoint) from the first RF coverage area can avoid full 802.1X authentication at the time of connecting to Wi-Fi APs in the second RF coverage area.

### BACKGROUND

Pairwise Master Key (PMK) caching is a mechanism that facilitates the authentication of Wi-Fi clients that roam between Wi-Fi access points (APs) in a network. At the time a Wi-Fi client first connects to a Wi-Fi AP in a network, the client undergoes an authentication process (known as full 802.1X authentication) that includes, among other things, deriving a PMK. This PMK is a cryptographic key that serves as a seed for generating other cryptographic keys used for encrypting communication between the Wi-Fi client and the Wi-Fi AP.

Upon being derived, the PMK is stored in a PMK cache by the Wi-Fi client and the Wi-Fi AP respectively, as well as shared with other Wi-Fi APs in the same network that are within radio frequency (RF) range of the Wi-Fi AP. If the Wi-Fi client thereafter roams to any of the other Wi-Fi APs which have a copy of the PMK in their PMK cache, the client can connect to that AP using the cached PMK without undergoing full 802.1X authentication again, resulting in a fast handoff.

### BRIEF DESCRIPTION OF THE DRAWINGS

With respect to the discussion to follow and in particular to the drawings, it is stressed that the particulars shown represent examples for purposes of illustrative discussion and are presented in the cause of providing a description of principles and conceptual aspects of the present disclosure. In this regard, no attempt is made to show implementation details beyond what is needed for a fundamental understanding of the present disclosure. The discussion to follow, in conjunction with the drawings, makes apparent to those of skill in the art how embodiments in accordance with the present disclosure may be practiced. Similar or same reference numbers may be used to identify or otherwise refer to similar or same elements in the various drawings and supporting descriptions. In the accompanying drawings:

FIG. 1 depicts an example Wi-Fi deployment in accordance with certain embodiments of the present disclosure.

FIGS. 2A and 2B depict an example scenario in the Wi-Fi deployment of FIG. 1 in accordance with certain embodiments of the present disclosure.

FIG. 3 depicts an intelligent PMK cache sharing workflow in accordance with certain embodiments of the present disclosure.

FIGS. 4A and 4B depict another example scenario in the Wi-Fi deployment of FIG. 1 in accordance with certain embodiments of the present disclosure.

FIG. 5 depicts an example Wi-Fi AP in accordance with certain embodiments of the present disclosure.

### DETAILED DESCRIPTION

In the following description, for purposes of explanation, numerous examples and details are set forth in order to provide an understanding of embodiments of the present disclosure. Particular embodiments as expressed in the claims may include some or all of the features in these examples, alone or in combination with other features described below, and may further include modifications and equivalents of the features and concepts described herein.

Embodiments of the present disclosure are directed to techniques for intelligently sharing PMK cache information among Wi-Fi APs in a network. With these techniques, Wi-Fi clients that roam from a first RF coverage area of the network to a second RF coverage area of the network that is separate (i.e., disjoint) from the first RF coverage area can avoid full 802.1X authentication at the time of connecting to Wi-Fi APs in the second RF coverage area.

### 1. Example Wi-Fi Deployment

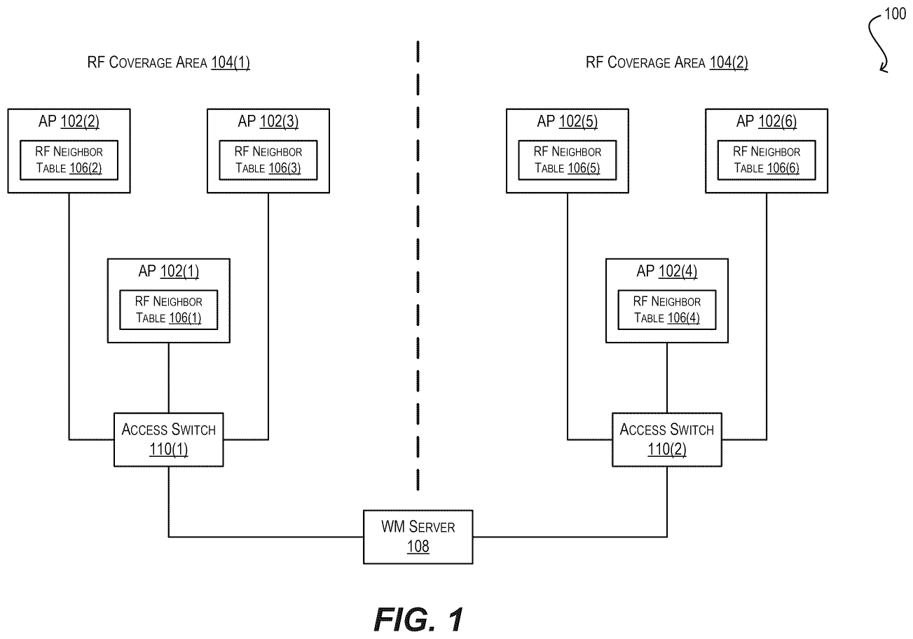

FIG. 1 is a simplified block diagram of an example Wi-Fi deployment 100 in which the techniques of the present disclosure may be implemented. As shown, Wi-Fi deployment 100 includes two sets of Wi-Fi APs 102(1)-(3) and 102(4)-(6) that are part of the same network but reside in two separate (disjoint) RF coverage areas 104(1) and 104(2). For example, Wi-Fi deployment 100 may be implemented in a building of an enterprise (such that Wi-Fi APs 102(1)-(6) are all part of the same enterprise network) and RF coverage areas 104(1) and 104(2) may represent two different floors or wings of the building.

RF coverage areas 104(1) and 104(2) are disjoint in the sense that the Wi-Fi APs in each RF coverage area are within RF range of each other but are not within RF range of the Wi-Fi APs in the other RF coverage area (due to, e.g., distance, obstacles, and/or other factors). Stated another way, there is a coverage gap between RF coverage areas 104(1) and 104(2) that prevents Wi-Fi communication across these areas.

Each Wi-Fi AP 102 maintains an RF neighbor table 106 that identifies other Wi-Fi APs within RF range of that Wi-Fi AP. Because Wi-Fi APs 102(1)-(3) in RF coverage area 104(1) are within RF range of each other, the RF neighbor tables of these Wi-Fi APs identify the other Wi-Fi APs in area 104(1). Similarly, because Wi-Fi APs 102(4)-(6) in RF coverage area 104(2) are within RF range of each other, the RF neighbor tables of these Wi-Fi APs identify the other Wi-Fi APs in area 104(2). For example, the following is a simplified representation of the contents of RF neighbor table 106(1) of Wi-Fi AP 102(1):

TABLE 1
RF Neighbor

Wi-Fi AP 102(2)
Wi-Fi AP 102(3)

And the following is a simplified representation of the contents of RF neighbor table 106(4) of Wi-Fi AP 102(4):

TABLE 2
RF Neighbor

Wi-Fi AP 102(5)
Wi-Fi AP 102(6)

In addition to the wireless topology described above, all Wi-Fi APs 102(1)-(6) in Wi-Fi deployment 100 are communicatively coupled via wired (e.g., Ethernet) connections with each other and with a wireless management (WM) server 108. For example, Wi-Fi APs 102(1)-(3) are wired to an access switch 110(1) residing in RF coverage area 104(1) and Wi-Fi APs 102(4)-(6) are wired to an access switch 110(2) residing in RF coverage area 104(2). Access switches 110(1) and 110(2) are in turn communicatively coupled via wired connections to each other and connected to WM server 108, which typically runs in the cloud or some other remote location. WM server 108 is a computer system or cluster of computer systems that is responsible for centrally managing, configuring, and monitoring the Wi-Fi APs in Wi-Fi deployment 100.

### 1.1 Conventional PMK Caching

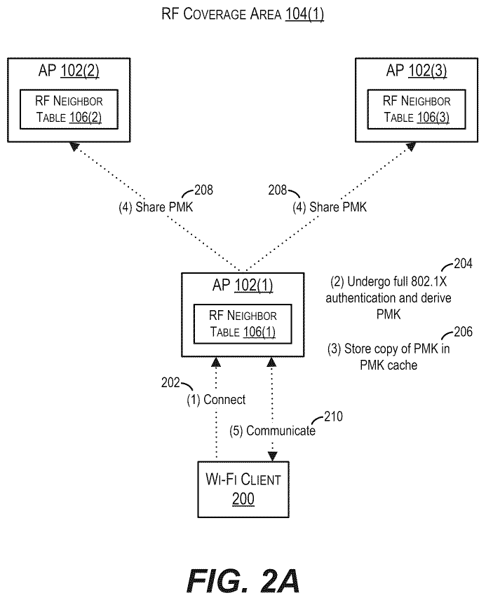

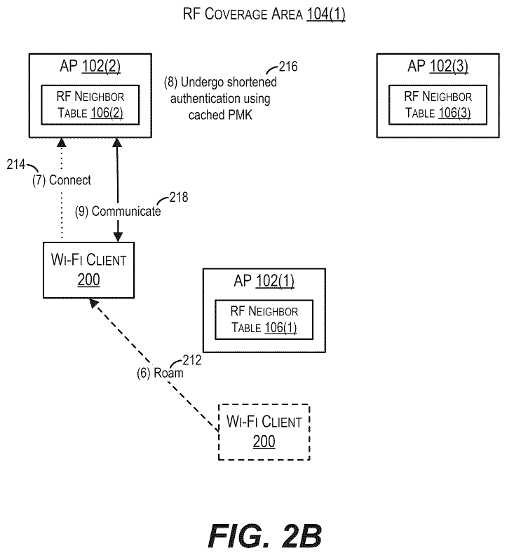

As mentioned previously, PMK caching is a mechanism that facilitates the authentication of Wi-Fi clients that roam (i.e., move) between Wi-Fi APs in a network. To illustrate how conventional PMK caching works in the context of Wi-Fi deployment 100 of FIG. 1, FIGS. 2A and 2B depict a scenario where a Wi-Fi client 200 roams from Wi-Fi AP 102(1) to Wi-Fi AP 102(2) in RF coverage area 104(1). Starting with FIG. 2A, Wi-Fi client 200 initially connects to Wi-Fi AP 102(1) (step (1); reference numeral 202) and, as part of the connection process, undergoes a full 802.1X authentication with Wi-Fi AP 102(1) (step (2); reference numeral 204). This full 802.1X authentication includes, among other things, deriving a PMK, which is a cryptographic key that serves as a seed for generating other cryptographic keys used for encrypting communication between Wi-Fi client 200 and Wi-Fi AP 102(1).

Once the PMK is derived, Wi-Fi client 200 and Wi-Fi AP 102(1) each store a copy of the PMK in a PMK cache that is local to those devices (step (3); reference numeral 206). Further, Wi-Fi AP 102(1) transmits, and thus shares, the cached PMK for Wi-Fi client 200 with all of the Wi-Fi APs defined in its RF neighbor table 106(1), which comprises Wi-Fi APs 102(2) and 102(3) (step (4); reference numeral 208). In response, Wi-Fi AP 102(2) and 102(3) each stores the cached PMK for Wi-Fi client 200 in its own local PMK cache (not shown). At step (5) (reference numeral 210), Wi-Fi client 200 and Wi-Fi AP 102(1) complete the connection process and begin communicating over the established Wi-Fi connection.

Turning now to FIG. 2B, after some period of time, Wi-Fi client 200 roams from Wi-Fi AP 102(1) to Wi-Fi AP 102(2) (step (6); reference numeral 212) and initiates a connection process with Wi-Fi AP 102(2) (step (7); reference numeral 214). As part of this process, Wi-Fi AP 102(2) recognizes that it has a cached copy of the PMK for Wi-Fi client 200 (which was shared by Wi-Fi AP 102(1) at step (4)). Accordingly, instead of undergoing full 802.1X authentication again, Wi-Fi client 200 undergoes a shortened authentication process with respect to Wi-Fi AP 102(2) that involves reusing the cached PMK (rather than deriving a new PMK) (step (8); reference numeral 216). Wi-Fi client 200 and Wi-Fi AP 102(2) then complete the connection process and begin communicating over the established Wi-Fi connection (step (9); reference numeral 218). Because PMK caching eliminates the need for full 802.1X authentication at step (8), Wi-Fi client 200 is able to connect to Wi-Fi AP 102(2) very quickly, resulting in a smooth handoff from Wi-Fi AP 102(1) to Wi-Fi AP 102(2).

One limitation with conventional PMK caching is that a given Wi-Fi AP only shares its PMK cache with other Wi-Fi APs that are defined in that Wi-Fi AP's RF neighbor table (and thus are within RF range). For example, in the scenario of FIGS. 2A and 2B, Wi-Fi AP 102(1) shares its PMK cache with Wi-Fi APs 102(2) and 102(3) in RF coverage area 104(1) (because those Wi-Fi APs are in RF neighbor table 106(1) of Wi-Fi AP 102(1)) but does not share it with Wi-Fi APs 102(4)-(6) in RF coverage area 104(2) (because those Wi-Fi APs are not in RF neighbor table 106(1) of Wi-Fi AP 102(1)). This means that any Wi-Fi clients which roam from RF coverage area 104(1) to RF coverage area 104(2) will have to undergo full 802.1X authentication again upon connecting to a Wi-Fi AP in area 104(1) (even though areas 104(1) and 104(2) are part of the same network), which is undesirable.

A workaround for this problem is for all Wi-Fi APs 102(1)-(6) to share, by default, their PMK caches with each other via their wired connections to access switches 110(1) and 110(2), instead of sharing only with RF neighbors. However, this approach does not scale well for large deployments comprising hundreds or thousands of Wi-Fi APs, because each Wi-Fi AP will need to maintain the cached PMKs from every other Wi-Fi AP in the deployment at all times, even if those PMKs are not actually needed (i.e., there are no instances of client roaming that utilize those PMKs).

### 2. Solution Overview

To address the foregoing and other similar problems, embodiments of the present disclosure provide techniques for sharing PMK caches across disjoint RF coverage areas of a Wi-Fi deployment, like coverage areas 104(1) and 104(2) of deployment 100, in an intelligent manner. At a high level, these techniques involve, by a Wi-Fi AP X residing in a RF coverage area A, (1) detecting, at the time of establishing a connection with a Wi-Fi client C1 for which AP X does not have a cached PMK, that client C1 previously connected to another Wi-Fi AP Y residing in a disjoint RF coverage area B (or in other words, that client C1 roamed from AP Y to AP X), (2) adding AP Y to its RF neighbor table as “temporary” RF neighbor, and (3) sending a message to AP Y requesting that AP Y add AP X as a neighbor in AP Y's RF neighbor table. Steps (2) and (3) cause AP Y to thereafter share the contents of its PMK cache with AP X but prevent AP X from propagating the PMK cache information received from AP Y to other Wi-Fi APs in RF coverage area A (due to AP Y's status as a temporary, rather than regular/non-temporary, RF neighbor).

The techniques further involve, by AP X, (4) detecting, at the time of establishing a connection with another Wi-Fi client C2, that client C2 previously connected to AP Y, (5) determining that there is a cached PMK for client C2 in its PMK cache (because it was shared by AP Y), (6) sharing the cached PMK for client C2 to other Wi-Fi APs in RF coverage area A, and (7) repeating steps (4)-(6) for further Wi-Fi clients (e.g., C3, C4, etc.) that roam from AP Y to AP X.

With the general approach above, several benefits are achieved. First, by detecting client C1 as a client that roamed from AP Y of RF coverage area B and by including AP Y as a temporary RF neighbor in its RF neighbor table, AP X can obtain the contents of AP Y's PMK cache across the coverage gap between RF coverage areas B and A in anticipation of further Wi-Fi clients roaming across this gap. Second, by detecting further instances of client roaming from AP Y (e.g., the roaming of client C2) and by propagating the cached PMK for each such Wi-Fi client to other Wi-Fi APs its RF coverage area (i.e., area A), AP X can proactively ensure that those other Wi-Fi APs have the cached PMKs ready in their respective PMK caches, under the assumption that those Wi-Fi clients will likely roam further into RF coverage area A.

Stated another way, the techniques of the present disclosure advantageously enable a Wi-Fi AP to obtain PMK cache information across a coverage gap and propagate that information to its RF neighbors on an as-needed basis, in accordance with detected instances of client roaming. Thus, these techniques scale far better than the workaround noted previously in which every Wi-Fi AP shares its PMK cache with every other Wi-Fi AP in a deployment by default (i.e., regardless of whether that shared PMK cache information is likely to be needed at the receiving APs).

### 3. Intelligent PMK Cache Sharing Workflow

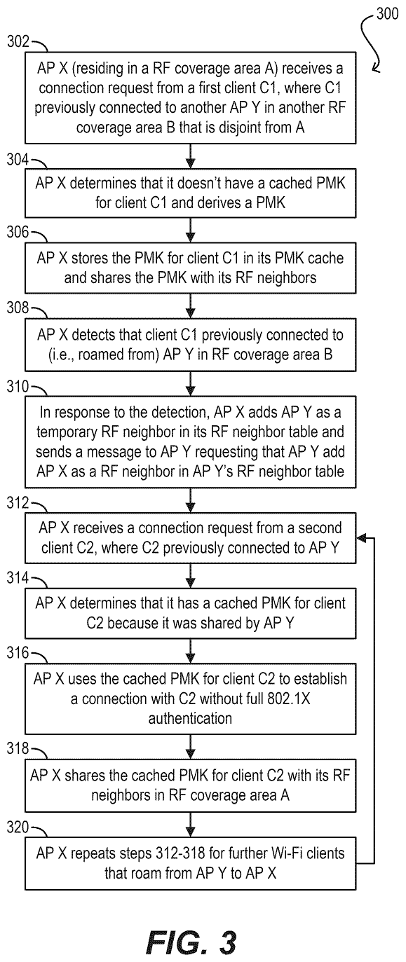

FIG. 3 is a workflow 300 that may be performed by a Wi-Fi AP X residing in an RF coverage area A for implementing intelligent PMK cache sharing in accordance with certain embodiments. Workflow 300 illustrates and elaborates upon the high-level approach described in the solution overview section above. Workflow 300 may be implemented in software, hardware, or a combination thereof. In the case of software, workflow 300 may be embodied in program code that is executable by one or more processors (e.g., central processing units (CPUs)) of AP X.

Starting with step 302, AP X can receive a connection request from a first Wi-Fi client C1, where client C1 previously connected to another Wi-Fi AP Y in another RF coverage area B that is separate/disjoint from RF coverage area A.

At step 304, AP X can determine that it does not have a cached PMK for client C1 in its PMK cache and can carry out full 802.1X authentication of C1, resulting in the derivation of a PMK. AP X can then store the derived PMK for client C1 in its PMK cache and can transmit (i.e., share) the PMK with all RF neighbors in its RF neighbor table (i.e., other Wi-Fi APs in RF coverage area A that are within RF range of AP X) (step 306).

At step 308, AP X can detect that client C1 previously connected to (or in other words, roamed from) AP Y in RF coverage area B. In one set of embodiments, AP X can perform this detection by sending an inquiry to a central WM server (like WM server 108 of FIG. 1) that manages the Wi-Fi deployment comprising RF coverage areas A and B and that maintains a history of client connections in the deployment.

In response to the detection at step 308, AP X can determine that client C1 roamed across a coverage gap/hole between AP Y and AP X (because AP X carried out a full 802.1X authentication of C1 even though C1 previously associated with AP Y). Accordingly, AP X can add AP Y to its RF neighbor table as a temporary RF neighbor and can send a message to AP Y (via, e.g., the WM server or a direct wired connection) requesting that AP Y add AP X as an RF neighbor in AP Y's RF neighbor table (step 310). This step causes AP Y to share its PMK cache from that point onward with AP X (because AP X is now in the RF neighbor table of AP Y) but prevents AP X from further sharing the PMK cache information received from AP Y with its RF neighbors in RF coverage area A (by virtue of AP Y's “temporary neighbor” designation in AP X's RF neighbor table).

At a later point in time, AP X can receive a connection request from a second Wi-Fi client C2, where client C2 previously connected to (or in other words, roamed from) AP Y in RF coverage area B after the occurrence of step 310 (step 312).

At step 314, AP X can determine that it holds a cached PMK for client C2 in its PMK cache because it was shared by AP Y as a result of step 310. AP X can then use this cached PMK to establish a connection with client C2 without full 802.1X authentication (step 316).

Upon establishing the connection with client C2, AP X can share the cached PMK for client C2 that it received from AP Y to all of its RF neighbors in RF coverage area A (step 318). AP X can thereafter repeat steps 312-318 for further Wi-Fi clients that roam from AP Y to AP X (step 320).

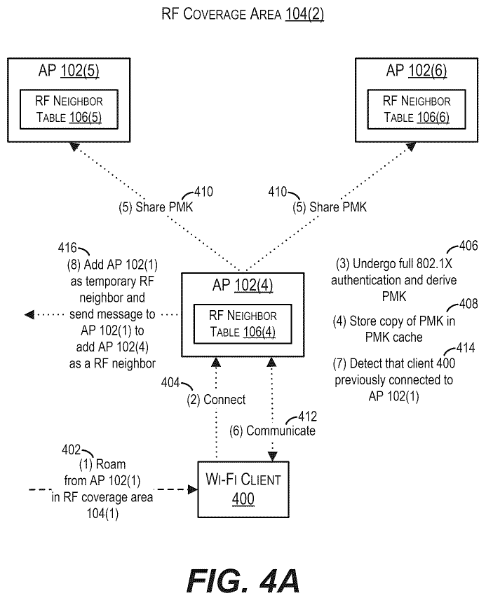

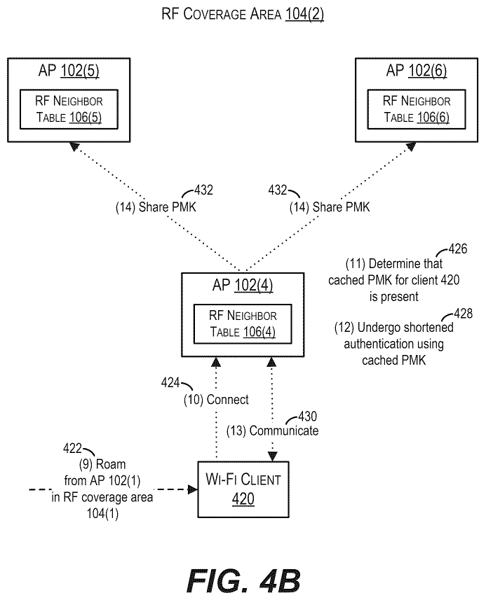

To provide a tangible example of the operation of workflow 300, FIGS. 4A and 4B depict a scenario with respect to Wi-Fi deployment 100 of FIG. 1 where two Wi-Fi clients roam from Wi-Fi AP 102(1) in RF coverage area 104(1) to Wi-Fi AP 102(4) in RF coverage area 104(2), and where Wi-Fi AP 102(4) implements intelligent PMK cache sharing. Starting with FIG. 4A, a first Wi-Fi client 400 roams from RF coverage area 104(1) (step (1); reference numeral 402) and connects to Wi-Fi AP 102(4), after having previously connected to Wi-Fi AP 102(1) (step (2); reference numeral 404). As part of the connection process, Wi-Fi client 400 undergoes a full 802.1X authentication because Wi-Fi AP 102(4) does not have a cached PMK for this client in its PMK cache (step (3); reference numeral 406). This full 802.1X authentication includes deriving a PM for Wi-Fi client 400.

Once the PMK is derived, Wi-Fi client 400 and Wi-Fi AP 102(4) each store a copy of the PMK in a PMK cache that is local to those devices (step (4); reference numeral 408) and Wi-Fi AP 102(4) shares the cached PMK with all RF neighbors defined in its RF neighbor table 106(4) (i.e., Wi-Fi APs 102(5) and 102(6)) (step (5); reference numeral 410). Upon receiving this cached PMK, Wi-Fi AP 102(5) and 102(6) each stores it in its own local PMK cache (not shown). Wi-Fi client 400 and Wi-Fi AP 102(4) then complete the connection process and begin communicating over the established Wi-Fi connection (step (6); reference numeral 412).

Further, Wi-Fi AP 102(4) detects (via, e.g., communicating with WM server 108) that Wi-Fi client 400 previously connected to Wi-Fi AP 102(1) in RF coverage area 104(1) (step (7); reference numeral 414). In response, Wi-Fi AP 102(4) adds Wi-Fi AP 102(1) as a temporary RF neighbor in its RF neighbor table 106(4) and sends a message to Wi-Fi AP 102(1) to add AP 102(4) as an RF neighbor in AP 102(1)'s RF neighbor table (step (8); reference numeral 416). For example, the following are simplified representations of the RF neighbor tables of Wi-Fi APs 102(4) and 102(1) respectively at the conclusion of step (8):

TABLE 3
(RF neighbor table of Wi-Fi AP 102(4))
RF Neighbor

Wi-Fi AP 102(5)
Wi-Fi AP 102(6)
Wi-Fi AP 102(1) (temporary)

TABLE 4
(RF neighbor table of Wi-Fi AP 102(1))
RF Neighbor

Wi-Fi AP 102(2)
Wi-Fi AP 102(3)
Wi-Fi AP 102(4)

The addition of Wi-Fi AP 102(4) to the Wi-Fi AP 102(1)'s RF neighbor table indicates to Wi-Fi AP 102(1) that it should share its PMK cache with Wi-Fi AP 102(4) from that point onward. Upon receiving such PMK cache information from Wi-Fi AP 102(1), Wi-Fi AP 102(4) stores it in its PMK cache 106(4). Further, the designation of Wi-Fi AP 102(1) as a temporary RF neighbor in Wi-Fi AP 102(4)'s RF neighbor table indicates to Wi-Fi AP 102(4) that it should not propagate any PMK cache information received from Wi-Fi AP 102(1) to its other, non-temporary/regular RF neighbors (i.e., Wi-Fi APs 102(5) and 102(6)).

Turning now to FIG. 4B, after some period of time, a second Wi-Fi client 420 roams from RF coverage area 104(1) (step (9); reference numeral 422) and connects to Wi-Fi AP 102(4), after having previously connected to Wi-Fi AP 102(1) (step (10); reference numeral 424). As part of this process, Wi-Fi AP 102(4) determines that it has a cached PMK for Wi-Fi client 420 in its PMK cache 106(4) because it was shared by Wi-Fi AP 102(1) (step (11); reference numeral 426). Accordingly, instead of undergoing full 802.1X authentication, Wi-Fi client 420 undergoes a shortened authentication process with respect to Wi-Fi AP 102(4) that involves reusing the cached PMK (rather than deriving a new PMK) (step (12); reference numeral 428). Wi-Fi client 420 and Wi-Fi AP 102(4) then complete the connection process and begin communicating over the established Wi-Fi connection (step (13); reference numeral 430).

Finally, Wi-Fi AP 102(4) shares the cached PMK for Wi-Fi client 420 that it received from Wi-Fi AP 102(1) to its RF neighbors in RF coverage area 104(2) (i.e., Wi-Fi APs 102(5) and 102(6)) (step (14); reference numeral 432). Note that Wi-Fi AP 102(4) performs this sharing of Wi-Fi AP 102(1)'s PMK cache information despite Wi-Fi AP 102(1)'s designation as a temporary RF neighbor because Wi-Fi AP 102(4) has now detected two instances of client roaming from Wi-Fi AP 102(1) (client 400 and client 420). In some embodiments, prior to sharing the cached PMK for Wi-Fi client 420 with its RF neighbors, Wi-Fi AP 102(4) may change the status of Wi-Fi AP 102(1) in its RF neighbor table 106(4) from temporary to regular/non-temporary.

### 4. Example Wi-Fi AP

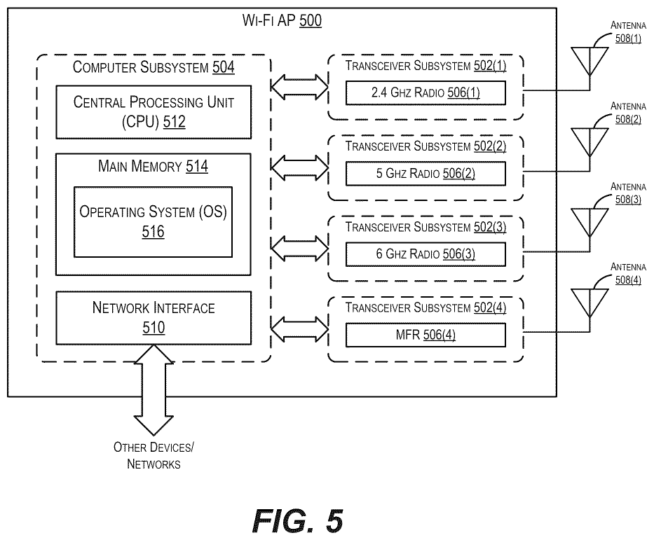

FIG. 5 is a simplified block diagram illustrating the architecture of an example Wi-Fi AP 500 according to certain embodiments. Wi-Fi AP 500 may be used to implement any of the Wi-Fi APs described in the foregoing sections. As shown, Wi-Fi AP 500 comprises a set of transceiver subsystems 502(1)-(4) that are communicatively coupled with a computer subsystem 504.

Each transceiver subsystem 502 includes, among other things, a radio 506 that transmits and receives RF signals via a corresponding antenna 508. In transceiver subsystems 502(1) through 502(3), each radio 506(1)/506(2)/506(3) supports a particular Wi-Fi frequency band and is configured to operate on one or more channels (i.e., frequency ranges) in that band, thereby enabling Wi-Fi communication between Wi-Fi AP 500 and other Wi-Fi devices (e.g., clients and other APs). For example, transceiver subsystem 502(1) has a 2.4 GHz radio 506(1) that is configured to operate on one or more channels in the 2.4 GHz frequency band (thereby enabling communication with 2.4 GHz clients/APs), transceiver subsystem 502(2) has a 5 GHZ radio 506(2) that is configured to operate on one or more channels in the 5 GHz frequency band (thereby enabling communication with 5 GHz clients/APs), and transceiver subsystem 502(3) has a 6 GHz radio 506(3) that is configured to operate on one or more channels in the 6 GHZ frequency band (thereby enabling communication with 6 GHz clients/APs).

Transceiver subsystem 502(4) has a special type of radio 506(4), known as a multi-function radio (MFR), that is configured to carry out various functions beyond providing standard Wi-Fi connectivity. Examples of such functions include wireless intrusion detection, network health monitoring, and channel scanning.

Computer subsystem 504 of Wi-Fi AP 500 includes, among other things, a network interface 510, a central processing unit (CPU) 512, and a main memory (e.g., random-access memory or RAM) 514. Network interface 510 connects Wi-Fi AP 500 to a wired network, typically through one or more Ethernet ports. For example, network interface 510 may connect Wi-Fi AP 500 via a wired connection to one or more access switches like switches 110(1) and 110(2) of FIG. 1. CPU 512 is a general purpose processor that is responsible for managing the configuration and operation of Wi-Fi AP 500 and its constituent components, including transceiver subsystems 502(1)-(4). CPU 512 performs these tasks under the direction of an operating system (OS) 516 that runs on CPU 512 from main memory 514. In certain embodiments, OS 516 may include program code that is configured to carry out the intelligent PMK cache sharing techniques of the present disclosure, including workflow 300 of FIG. 3. This program code may be held in main memory 514, along with the PMK cache and RF neighbor table described in the foregoing sections.

The above description illustrates various embodiments of the present disclosure along with examples of how aspects of these embodiments may be implemented. The above examples and embodiments should not be deemed to be the only embodiments and are presented to illustrate the flexibility and advantages of the present disclosure as defined by the following claims. For example, although certain embodiments have been described with respect to particular workflows and steps, it should be apparent to those skilled in the art that the scope of the present disclosure is not strictly limited to the described workflows and steps. Steps described as sequential may be executed in parallel, order of steps may be varied, and steps may be modified, combined, added, or omitted. As another example, although certain embodiments may have been described using a particular combination of hardware and software, it should be recognized that other combinations of hardware and software are possible, and that specific operations described as being implemented in hardware can also be implemented in software and vice versa.

The specification and drawings are, accordingly, to be regarded in an illustrative rather than restrictive sense. Other arrangements, embodiments, implementations, and equivalents will be evident to those skilled in the art and may be employed without departing from the spirit and scope of the present disclosure as set forth in the following claims.

1. A method performed by a first Wi-Fi access point (AP) in a first radio frequency (RF) coverage area of a network, the method comprising:
receiving a connection request from a first Wi-Fi client, wherein the first Wi-Fi client previously connected to a second Wi-Fi AP in a second RF coverage area of the network that is disjoint from the first RF coverage area;
determining that there is no Pairwise Master Key (PMK) for the first Wi-Fi client in a PMK cache of the first Wi-Fi AP;
engaging in a full 802.1X authentication with the first Wi-Fi client, resulting in derivation of a first PMK for the first Wi-Fi client;
storing the first PMK in the PMK cache of the first Wi-Fi AP and sharing the first PMK with one or more other Wi-Fi APs in the first RF coverage area;
detecting that the first Wi-Fi client previously connected to the second Wi-Fi AP; and
in response to the detecting:
adding the second Wi-Fi AP as a temporary RF neighbor in a RF neighbor table of the first Wi-Fi AP; and
sending a message to the second Wi-Fi AP to add the first Wi-Fi AP as a RF neighbor in a RF neighbor table of the second Wi-Fi AP.

2. The method of claim 1 further comprising:
receiving, from the second Wi-Fi AP, PMK cache information held in a PMK cache of the second Wi-Fi AP; and
storing the PMK cache information in the PMK cache of the first Wi-Fi AP.

3. The method of claim 2 wherein the adding of the second Wi-Fi AP as a temporary RF neighbor in the RF neighbor table of the first Wi-Fi AP prevents the first Wi-Fi AP from propagating the PMK cache information received from the second Wi-Fi AP to the one or more other Wi-Fi APs in the first RF coverage area.

4. The method of claim 2 further comprising:
receiving a connection request from a second Wi-Fi client, wherein the second Wi-Fi client previously connected to the second Wi-Fi AP in the second RF coverage area;
determining that there is a second PMK for the second Wi-Fi client in the PMK cache of the first Wi-Fi AP; and
in response to the determining:
engaging in a shortened authentication process with the second Wi-Fi client that uses the second PMK; and
sharing the second PMK with the one or more other Wi-Fi APs in the first RF coverage area.

5. The method of claim 4 wherein the second PMK was included in the PMK cache information received from the second Wi-Fi AP.

6. The method of claim 4 wherein the second Wi-Fi client connected to the second Wi-Fi AP after the sending of the message to the second Wi-Fi AP.

7. The method of claim 4 further comprising:
changing the second Wi-Fi AP in the RF neighbor table of the first Wi-Fi AP from being a temporary RF neighbor to being a non-temporary or regular RF neighbor.

8. The method of claim 1 wherein the first Wi-Fi AP is communicatively coupled with the second Wi-Fi AP via a wireless management server, and wherein the first Wi-Fi AP detects that the first Wi-Fi client previously connected to the second Wi-Fi AP by sending an inquiry to the wireless management server.

9. The method of claim 2 wherein the first Wi-Fi AP is communicatively coupled with the second Wi-Fi AP via a wireless management server, and wherein the first Wi-Fi AP receives the PMK cache information from the second Wi-Fi AP through the wireless management server.

10. A first Wi-Fi access point (AP) residing in a first radio frequency (RF) coverage area of a network, the first Wi-Fi AP comprising:
a processor; and
a memory having stored thereon program code that, when executed by the processor, causes the processor to:
receive a connection request from a first Wi-Fi client, wherein the first Wi-Fi client previously connected to a second Wi-Fi AP in a second RF coverage area of the network that is disjoint from the first RF coverage area;
determine that there is no Pairwise Master Key (PMK) for the first Wi-Fi client in a PMK cache of the first Wi-Fi AP;
engage in a full 802.1X authentication with the first Wi-Fi client, resulting in derivation of a first PMK for the first Wi-Fi client;
store the first PMK in the PMK cache of the first Wi-Fi AP and share the first PMK with one or more other Wi-Fi APs in the first RF coverage area;
detect that the first Wi-Fi client previously connected to the second Wi-Fi AP; and
in response to the detecting:
add the second Wi-Fi AP as a temporary RF neighbor in a RF neighbor table of the first Wi-Fi AP; and
send a message to the second Wi-Fi AP to add the first Wi-Fi AP as a RF neighbor in a RF neighbor table of the second Wi-Fi AP.

11. The first Wi-Fi AP of claim 10 wherein the program code further causes the processor to:
receive, from the second Wi-Fi AP, PMK cache information held in a PMK cache of the second Wi-Fi AP; and
store the PMK cache information in the PMK cache of the first Wi-Fi AP.

12. The first Wi-Fi AP of claim 11 wherein the adding of the second Wi-Fi AP as a temporary RF neighbor in the RF neighbor table of the first Wi-Fi AP prevents the first Wi-Fi AP from propagating the PMK cache information received from the second Wi-Fi AP to the one or more other Wi-Fi APs in the first RF coverage area.

13. The first Wi-Fi AP of claim 11 wherein the program code further causes the processor to:
receive a connection request from a second Wi-Fi client, wherein the second Wi-Fi client previously connected to the second Wi-Fi AP in the second RF coverage area;
determine that there is a second PMK for the second Wi-Fi client in the PMK cache of the first Wi-Fi AP; and
in response to the determining:
engage in a shortened authentication process with the second Wi-Fi client that uses the second PMK; and
share the second PMK with the one or more other Wi-Fi APs in the first RF coverage area.

14. The first Wi-Fi AP of claim 13 wherein the second PMK was included in the PMK cache information received from the second Wi-Fi AP.

15. The first Wi-Fi AP of claim 13 wherein the second Wi-Fi client connected to the second Wi-Fi AP after the sending of the message to the second Wi-Fi AP.

16. The first Wi-Fi AP of claim 13 wherein the program code further causes the processor to:
change the second Wi-Fi AP in the RF neighbor table of the first Wi-Fi AP from being a temporary RF neighbor to being a non-temporary or regular RF neighbor.

17. The first Wi-Fi AP of claim 10 wherein the first Wi-Fi AP is communicatively coupled with the second Wi-Fi AP via a wireless management server, and wherein the first Wi-Fi AP detects that the first Wi-Fi client previously connected to the second Wi-Fi AP by sending an inquiry to the wireless management server.

18. The first Wi-Fi AP of claim 11 wherein the first Wi-Fi AP is communicatively coupled with the second Wi-Fi AP via a wireless management server, and wherein the first Wi-Fi AP receives the PMK cache information from the second Wi-Fi AP through the wireless management server.

19. A method performed by a first Wi-Fi access point (AP) in a first radio frequency (RF) coverage area of a network, the method comprising:
receiving a connection request from a first Wi-Fi client;
detecting that the first Wi-Fi client previously connected to a second Wi-Fi AP in a second RF coverage area of the network that is different from the first RF coverage area; and
in response to the detecting:
adding the second Wi-Fi AP as a temporary RF neighbor in a RF neighbor table of the first Wi-Fi AP; and
sending a message to the second Wi-Fi AP to add the first Wi-Fi AP as a RF neighbor in a RF neighbor table of the second Wi-Fi AP.

20. The method of claim 19 further comprising:
receiving a connection request from a second Wi-Fi client, wherein the second Wi-Fi client previously connected to the second Wi-Fi AP in the second RF coverage area;
determining that there is a PMK for the second Wi-Fi client in a PMK cache of the first Wi-Fi AP; and
in response to the determining, sharing the PMK with one or more other Wi-Fi APs in the first RF coverage area.
